(19) United States
(12) Patent Application Publication
(10) Pub. No.: US 2004/0101648 A1
(43) Pub. Date: May 27, 2004

(54) Sheet labels

(76) Inventors: Patricia M. Mulvey, Neenah, WI (US); Ronald G. Hagen, Larsen, WI (US)

Correspondence Address: John D. Franzini, Quarles & Brady, LLP, 411 East Wisconsin Avenue, Milwaukee, WI, 53202, US

(21) Appl. No.: 10/302,252

(22) Filed: Nov. 22, 2002

(51) Int. Cl. B32B 9/00; B32B 3/16; B32B 31/18

(52) U.S. Cl. 428/42.3; 428/156; 156/239; 156/268; 156/269

(57) ABSTRACT

A plurality of two-ply labels in sheet form include base and top layers on a single backing sheet with a release surface to which the transparent base layer is adhered with a transparent pressure sensitive adhesive. The top layer is unprinted paper releasably adhered to the upper side of the base layer by a dry residue adhesive. The top and base layers are cut to define a grid of printable labels and the sheets are of a size that can be fed through an inkjet or laser printer or copier. The adhesion between the base and top layers is less than the internal cohesion of the base and top layers and the adhesion of the pressure-sensitive adhesive. A user can print the labels and peel them from the backing sheet, apply them to a product or other substrate, and the top layer can then be peeled from the base layer leaving the transparent base layer adhered to the substrate with the separated top sheet and the exposed surface of the base layer substantially tack-free. A method of making and using such a label sheet is also disclosed.

### CROSS-REFERENCE TO RELATED APPLICATION

Not applicable.

### STATEMENT OF GOVERNMENT SPONSORED DEVELOPMENT

Not Applicable.

### BACKGROUND OF THE INVENTION

This invention relates to labels and in particular to providing multi-ply labels in a single sheet construction for user printing and application.

Point of purchase promotional items can be an effective marketing tool for the sale of consumer products. One common technique is to attach the promotional items directly to the products being displayed for sale. The promotional items can be adhesive backed labels that are either removable or have tear-away panels. These labels can be coupons that consumers can peel off the product or peel-off tokens or entry forms for a promotional game or giveaway.

Some such labels have multiple layers releasably adhered together. For example, U.S. Pat. No. 4,479,838, hereby incorporated by reference as though fully set forth herein, defines a multiple ply label construction with a transparent base sheet to which is releasably adhered a non-transparent top sheet printed to define a coupon, for example. These two layers are adhered to a release liner. Such a label is used by peeling the base sheet (with the top sheet attached) from the release liner and adhering it to a product. The top sheet can later be removed from the base sheet, for example when the purchaser of the product redeems the coupon.

These labels are printed on a printing press prior to joining the top and base sheets and are applied using automated line processes. Large quantities of labels are formed in a single file line of labels on a continuous backing web that is either wound into a roll or folded, for example, in a Z-fold configuration. This can be cumbersome or impractical to work with if the labels are to be applied manually and/or to a small quantity of products. Cutting the web into numerous single labels makes storage and shipment more difficult, and does not permit user customization of the indicia displayed on the labels.

Self adhesive labels, like mailing labels, are commonly available in sheet form, in sheet sizes that can be fed through ordinary inkjet and laser printers and copiers for printing and application by the user. These are single ply with pressure sensitive adhesive, and once applied to a substrate are not easy to remove, and if removed exposes the pressure sensitive adhesive or tears the substrate or label.

Thus, an improved multi-layer releasable label construction for user printing and application is needed.

### BRIEF SUMMARY OF THE INVENTION

In one aspect the invention provides a sheet label construction defining a grid of labels made of base and top layers on a single backing sheet that can be fed through and printed with common inkjet or laser printers or copiers. The backing sheet has a release surface to which is releasably adhered a pressure sensitive underside of the base layer. The top layer is releasably adhered to a top side of the base sheet by a dry release adhesive. Cut lines through the top and base layers define the grid of two-ply labels backed by the backing sheet. The adhesion between the base layer and the top layer is less than the internal cohesion of the base and top layers. The top layer is blank and printable to be subsequently printed by a user, for example in an ordinary inkjet or laser printer or copier.

In other preferred forms, the base layer and adhesives are substantially transparent. The adhesive between the base and top layers is a dry residue adhesive such that the top layer can be removed from the base layer without leaving a tacky residue on the once mated face surfaces of the base and top layers. The adhesive between the base layer and the backing sheet is a pressure sensitive adhesive for at least semi-permanently adhering the base layer to a mounting surface such that the adhesion between the top and base layers is less than that between the base layer and the mounting surface. The top layer can be paper or other non-transparent material capable of receiving ink and the base layer is preferably a transparent polymeric film, although it may also be paper, and could be printed.

In another aspect the invention provides a method of making a sheet label structure as described above. The method includes: providing a web of a backing sheet having a release surface; adhering a web of a base layer having upper and under sides to the release surface of the backing sheet with a pressure sensitive adhesive; adhering a web of a top layer to the upper side of the base layer over the adhesive; and cutting through the top and base layers without cutting the backing sheet so as to define a grid of two-ply labels releasably mounted on the backing sheet. The adhesion of the top layer to the base layer is less then the internal cohesion of the top and base layers such that the base and top layers can be peeled from the backing sheet and applied to a mounting surface and then the top layer can be peeled away from the base sheet, which remains on the mounting surface.

This continuous line process can be used to form a plurality of sheets of labels. The multi-layer web can be cut through the backing sheet to define separate sheets or sheets separated by perforations or fold lines that are wound or folded attached to one another, that can be fed through and printed in an ordinary office or household printer or copier.

A user of a sheet of labels of the invention can feed the sheets into his or her printer or copier and determine what images are printed on each label him or herself, manipulating the indicia of each label with his or her computer, connected to the printer. Any number of labels can be printed at any time by the user and bearing any indicia, to yield a flexibility heretofore unknown in the application of removeable dry release labels. The user can then apply the labels to a product or other substrate, so the top sheet can be removed leaving the base sheet on the substrate and the top and base sheet exposed surfaces non-tacky.

The advantages of the invention will appear from the following description. In this description, reference is made to the accompanying drawings which form a part hereof and in which there is shown by way of illustration preferred embodiments of the invention. These embodiments do not represent the full scope of the invention. Thus, the claims should be looked to in order to ascertain the scope of the invention.

### BRIEF DESCRIPTION OF THE DRAWINGS

FIG. 1 is a plan view of sheet label construction according to the present invention in which the top sheets are unprinted;

FIG. 2 is a cross-sectional view taken along line 2-2 of FIG. 1 showing the sheet label with the thicknesses of its layers greatly exaggerated;

FIG. 3 is plan view showing a section of a multi-layer web assembly in a continuous line manufacturing process for making multiple sheet label sheets in which the top sheets are blank; and

FIG. 4 is a perspective view of a printed coupon label adhered to a product.

### DETAILED DESCRIPTION OF THE PREFERRED EMBODIMENT

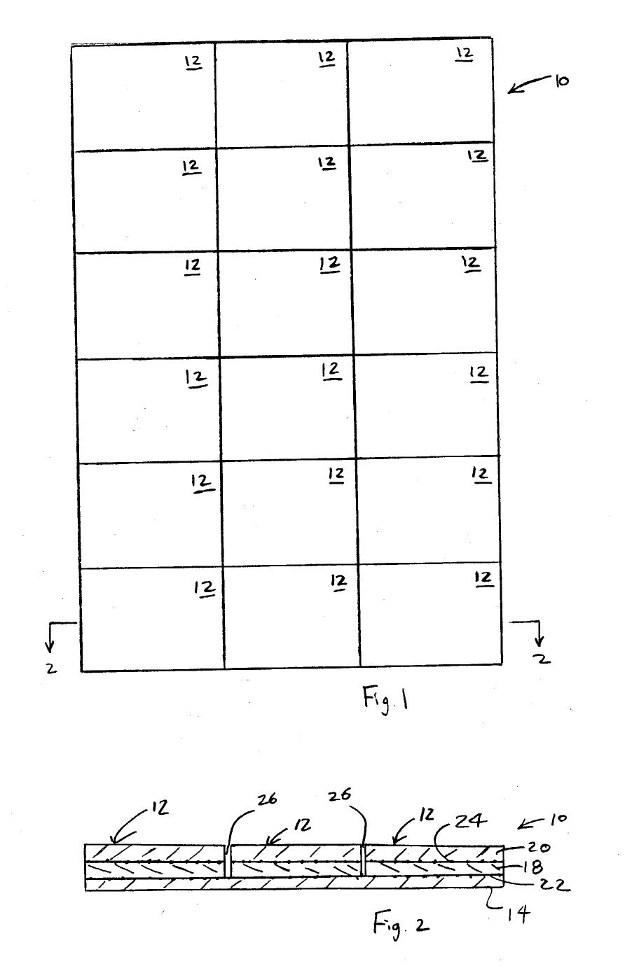

FIG. 1 shows a sheet label construction according to the present invention referenced generally by numeral 10. The sheet label 10 provides in single sheet form a plurality of adhesive labels 12 of two-ply construction, as shown in FIG. 2, preferably defining coupons. The sheet label 10 shown has a grid of six rows of three labels each.

Referring to FIG. 2, the sheet label 10 has two layers joined by adhesives and mounted on a release backing. In particular, a backing sheet 14 defines the full size of the sheet and has a smooth, release upper face. The backing sheet 16 supports the plurality of two-ply labels 12. Each label 12 has a base layer 18 and a top layer 20. The base layer 18 is preferably transparent and coated at its underside with a pressure-sensitive semi-permanent or permanent transparent adhesive 22. The top layer 20 is a non-transparent layer with a printable top surface. A transparent releasable adhesive 24 is disposed between the upper face of the base layer 18 and the underside of the top layer 20 so that the two layers are releasably joined together in the two-ply configuration.

In a preferred form, the base layer is made of a transparent film of polystyrene, preferably 0.002 inches thick, and is supplied backed with the release liner, with permanent pressure sensitive adhesive. The top layer is made of 60-pound uncoated offset material, preferably 0.0035 inches thick. The releasable adhesive is a dry residue adhesive, also known as a dry release adhesive, so that when the top layer is separated from the base layer the once previously mated surfaces are essentially tack-free. The top and base plies are dry release bonded by any suitable method. In the disclosed embodiment, in preparation for bonding, the upper surface of the base sheet may be first coated with a suitable varnish to seal its surface, such as WKA00014F available from Sun Chemical of Menasha, Wis. Following curing of the varnish, the top surface of the base sheet may be coated with a suitable release agent, such as PCF3 release agent, available as #RAW00146 from Flint of Milwaukee, Wis. Following curing of the release agent, a suitable water base adhesive, such as #3487 from H. B. Fuller of Minneapolis/St. Paul, Minn., may be used to bond the two sheets together. Other methods may also be used, such as that described in U.S. Pat. No. 4,479,838, referred to above.

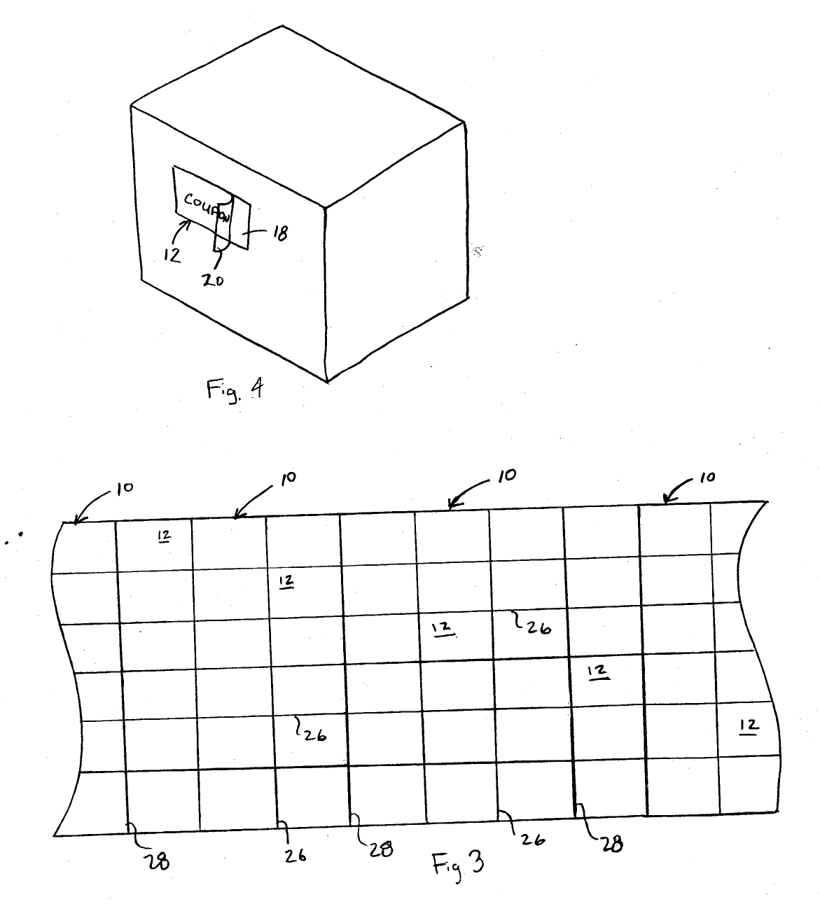

With reference to FIG. 3, multiple sheet labels 10 can be manufactured in a continuous line process. Specifically, a reel of the base layer backed with the release liner (backing sheet) is unwound. The dry residue adhesive is applied by any suitable method, such as printing with an anilox roller. A reel of the top layer, which is unprinted, is unwound and brought together with the unwound section of base layer so that its underside contacts the dry residue adhesive while it is still uncured. This web assembly is passed through a cutter which cuts through the top and base layers but not the release liner. The cut lines 26 thus define multiple rows and columns of the two-ply labels. The number of labels per sheet depends on the size of the labels and the size of the web layers. The sheet and labels are shown and described as being cut into simple rectangular shapes. A preferred size for the sheets is 8½″×11″ (letter size), A4 (international size), 8½″×14″ (legal size) or any other common size of printer or copier paper.

Rectilinearly shaped labels are advantageous because the labels can be cut out with minimal waste, being spaced apart only by the thin cut lines. However, any desired shape can be achieved. Spaces are shown at the cut lines 26 in FIG. 2 to illustrate that the labels are separate, although in practice the labels may not be spaced apart but only separated by a slit. If it is desired to space the labels apart further, a waste matrix around the individual labels can be stripped from the release liner to facilitate removal of the labels during application. In any event, the web assembly is preferably cut along lines 28 through all layers (including the release liner) to form the individual sheets. However, if desired, the individual sheets could be defined by fold lines or perforations (through all layers) so that rather than be separate the sheets remain connected to one another. In this case, the sheets can be folded, for example in a fan or “Z” fold configuration, or wound on a reel.

Each label can be peeled off of the backing sheet individually and attached to a product or to packaging by the pressure-sensitive adhesive on the underside of the base layer. The adhesive coating releases from the backing sheet but strongly adheres to the product/packaging in a permanent or semi-permanent manner. As shown in FIG. 4, once a label is applied to the product, the top layer can be peeled from the base layer and removed. The dry residue adhesive leaves only a non-tacky, substantially transparent residue on the once mated surfaces. The base layer will remain adhered to the product, however, since it is transparent it does not visually obstruct any printing on the product or its packaging and is generally unnoticeable.

The present invention thus provides in a single sheet form multiple two-ply labels, which can be used to apply promotional items, such as coupons, to products and displays. The sheet label is comprised of common stock polymeric, paper, foil or other thin sheet materials, and the labels can be assembled in a continuous line manner. The sheet form provides a convenient method of presenting and storing multiple labels before use that is particularly well-suited for user printing and application.

While there has been shown and described what is at present considered to be the preferred embodiment of the invention, it will be obvious to those skilled in the art that various changes and modifications can be made to the described device without departing from the scope of the present invention. For example, the base layer need not be transparent, and a blank or unprinted label would include labels that have substantial blank or unprinted areas for printing, i.e., a label with a preprinted border or other indicia around a substantial blank printable area is considered blank and unprinted. In addition, the top of the base layer and/or the back of the top layer could be printed or not. Accordingly, to ascertain the full scope of the invention, reference must be made to the following claims.

What is claimed is:

1. An individual sheet label construction, comprising:
a backing sheet having a release surface;
a base layer having a top side and an underside releasably adhered to the release surface of the backing sheet;
an unprinted printable top layer releasably adhered to the top side of the base sheet such that the adhesion between the base layer and the top layer is less than the internal cohesion of the base layer and the top layer;
wherein cut lines through the top and base layers define a grid of two-ply labels backed by the backing sheet.

2. The sheet label of claim 1, wherein each sheet is 8½″×11″, A4 or 8½″×14″ in size.

3. The sheet label of claim 1, wherein the base layer is substantially transparent.

4. The sheet label of claim 1, wherein the adhesive between the base and top layers is a dry residue adhesive such that the top layer can be removed from the base layer substantially tack-free.

5. The sheet label of claim 4, wherein the dry residue adhesive is substantially transparent.

6. The sheet label of claim 1, wherein the adhesive between the base layer and the backing sheet is a pressure sensitive adhesive that adheres the base layer to a mounting surface with greater adhesion than the adhesion between the top and base layers.

7. The sheet label of claim 6, wherein the pressure sensitive adhesive is substantially transparent.

8. The sheet label of claim 1, wherein the top layer is paper.

9. The sheet label of claim 1, wherein the base layer is polymeric film.

10. A method of making a sheet label structure, comprising the steps of:
providing a web of a backing sheet having a release surface;
providing a web of a base layer having upper and under sides;
adhering the under side of the base layer to the release surface of the backing sheet with a pressure sensitive adhesive;
adhering a web of a top layer to the upper side of the base layer with a releasable dry residue adhesive;
cutting through the top and base layers without cutting the backing sheet so as to define a grid of two-ply labels releasably mounted on the backing sheet;
wherein the adhesion of the top layer to the base layer is less than the internal cohesion of the top layer and the base layer such that the base and top layers can be peeled from the backing sheet and applied to a mounting surface and then the top layer can be peeled away from the base sheet.

11. The method of claim 10, further comprising the step of cutting through the top layer, base layer and the backing sheet to define separate individual backing sheets each having a plurality of two-ply labels thereon.

12. The method of claim 11, wherein the top layer is unprinted.

13. The method of claim 11, wherein the base layer is substantially transparent.

14. The method of claim 11, wherein the adhesive between the base and top layers is a dry residue adhesive such that the top layer can be removed from the base layer substantially tack-free.

15. The method of claim 14, wherein the dry residue adhesive is substantially transparent.

16. The method of claim 11, wherein the adhesive between the base layer and the backing sheet is a pressure sensitive adhesive adhering the base layer to the mounting surface with greater adhesion than the adhesion between the top and base layers.

17. The method of claim 16, wherein the pressure sensitive adhesive is substantially transparent.

18. The method of claim 11, wherein the top layer is paper.

19. The method of claim 11, wherein the base layer is polymeric film.

20. The method of claim 11, further comprising cutting each sheet to a size of 8½″×11″, A4 or 8½″×14″.

21. A method of making dry release labels, comprising the steps of:
providing a web of a backing sheet having a release surface;
providing a web of a base layer having upper and under sides;
adhering the under side of the base layer to the release surface of the backing sheet with a pressure sensitive adhesive;
adhering a web of a top layer to the upper side of the base layer with a releasable dry residue adhesive;
cutting through the top and base layers without cutting the backing sheet so as to define at least one two-ply label releasably mounted on the backing sheet;
wherein the adhesion of the top layer to the base layer is less than the internal cohesion of the top layer and the base layer such that the base and top layers can be peeled from the backing sheet and applied to a mounting surface and then the top layer can be peeled away from the base sheet; and
printing an upper surface of the label by feeding the backing sheet bearing the label through a printer or copier.

22. The method of claim 21, further comprising the steps of removing the label including top layer and base layer from the backing sheet, applying the label to a substrate by adhering the underside of the base layer to the substrate and removing the top layer from the base layer.

23. The method of claim 21, wherein the top layer is adhered to the base layer with a releasable dry residue adhesive.

24. The method of claim 21, wherein cutting through the top and base layer defines a grid of labels on the backing sheet.
